(19) United States
(12) Patent Application Publication
(10) Pub. No.: US 2026/0369733 A1
(43) Pub. Date: Nov. 19, 2026

(54) Temperature Control Element, Temperature Control System With Such a Temperature Control Element, and Battery System

(71) Applicant: MAHLE International GmbH, Stuttgart (DE)

(72) Inventors: Thomas KALMBACH, Ostfildern (DE); Oleksandr PAVLOV, Plochingen (DE); Jessica KANSY, Stuttgart (DE)

(21) Appl. No.: 19/671,603

(22) Filed: May 8, 2026

(30) Foreign Application Priority Data
May 14, 2025 (DE) 102025118482.8

(51) Int. Cl. H01M 10/6556; B60L 58/26; H01M 10/04; H01M 10/613; H01M 10/625; H01M 10/6554; H01M 10/656; H01M 50/242

(52) U.S. Cl. CPC H01M 10/6556; B60L 58/26; H01M 10/0481; H01M 10/613; H01M 10/625; H01M 10/6554; H01M 10/656; H01M 50/242; H01M 2220/20

(57) ABSTRACT

A temperature control element for batteries in a stack forming a battery system for an electric or hybrid vehicle is provided, which has two temperature control plates along an axis passing through a row of plates, each of which has at least one channel through which a coolant can flow for controlling the temperature of the batteries, on each of which one of the batteries can be placed, and with at least one compression element between the two temperature control plates, which bears on the two temperature control plates, and can be compressed along the axis passing through the row of plates. A temperature control system and a battery system for a vehicle is also provided.

### CROSS-REFERENCE TO RELATED APPLICATIONS

This application claims priority from German Patent Application No. DE 102025118482.8, filed on May 14, 2025, the entirety of which is hereby incorporated by reference herein.

The present invention relates to a temperature control element for batteries in a battery system containing a stack of batteries for an electric vehicle or hybrid vehicle as set forth in Numbered Paragraph 1. The invention also relates to a temperature control system that contains such temperature control elements, and a battery system.

Efficient battery systems containing lithium-ion batteries, for example, are used in modern electric and hybrid vehicles. These batteries are usually stacked to form a unit. Means of controlling the temperature of the batteries are integrated in the stack, with which exhaust heat can be removed from the batteries, or heat can be transferred thereto as needed. This allows the batteries to be operated within an acceptable temperature range, thus improving their performance and increasing their service life.

Presently, it is not possible to prevent changes in the sizes of the batteries, in particular expansion thereof along the stack, that occurs during the intended operation thereof, specifically when charging and using the batteries, and as they age. As the expansion of the batteries increases along the stack, the forces acting within the stack increase steadily. This is problematic for a number of reasons, because it may result in exceeding the maximum acceptable loads to the batteries, thus damaging some of the batteries, and it may have a negative impact on the means for controlling the temperature integrated within the stack. Specifically, it may pinch off fluid channels therein, such that the temperature of the batteries cannot be effectively controlled.

The object of the invention is to create a better, or at least different, design for the battery temperature control elements. Specifically, it should be possible to control the temperature of a stack of batteries subjected to challenges described above more effectively. In addition, a better temperature control system and a better battery system should be obtained.

These problems are solved with the present invention by the subject matter of the independent Numbered Paragraphs. Advantageous embodiments are the subject matter of the dependent Numbered Paragraphs, the description, and the drawings.

The first of these problems is solved by a temperature control element for batteries in a stack of batteries forming a battery system for an electric or hybrid vehicle. The proposed temperature control element contains two parallel temperature control plates through which a coolant flows in channels, and on which at least one of the batteries can be placed, either directly or indirectly with an intermediate component therebetween. The temperature control element also has at least one compression element between the two temperature control plates, which contains linear compression chambers that can be compressed between the plates. This compression element is made of a material that conducts heat, preferably a metal, and can be filled with a gas or mixture of gasses, specifically air, or a fluid that can contribute to the temperature control.

This allows the temperature control element to be compressed between the plates, resulting in a certain flexibility in this direction. Consequently, swelling of the batteries along the stack, due to the charging state and aging, can be compensated for. Consequently, the load to the batteries remains within an acceptable range, even when they expand. As a result, the batteries do not exceed the maximum acceptable loads, and the temperature control plates, or the channels therein, are not impacted by the swelling of the batteries. Because the compression element is made of a thermally conductive material, a significant amount of heat can be transported between the temperature control plates in the temperature control element. Thermal exchange between the two temperature control plates can be limited or prevented by the gas or mixture of gasses, specifically air, in the compression chambers, due to the comparatively low thermal conductivity of gas, which is advantageous in preventing or reducing subsequent thermal propagation caused by thermal runaway in one of the batteries.

The expression, “compression of the temperature control element along the row” is understood to mean a compression, pinching or deformation of the temperature control element within the row, preferably in response to a force applied to the temperature control plates by the compression element. Swelling of the batteries is understood to be an expansion or widening thereof.

The mechanical rigidity of the compression element is lower than that of the two temperature control plates. This ensures that when the temperature control element is compressed, only the compression element is deformed, and not the two temperature control plates. Consequently, the channels within the temperature control plates are not significantly affected when the temperature control element is compressed. This means that the cross sections of the channels remain the same, or about the same, such that the flow of coolant remains constant. The temperature control of the batteries can therefore remain constant, even when the batteries expand. Moreover, pressure losses in the channels remain constant or nearly constant, such that the initial distribution of the coolant remains the same between numerous temperature control elements.

The expression, “mechanical rigidity” refers to the resistance of an element to deformation caused by external forces.

Ideally, the compression element can be resiliently compressed between the plates. This means that the compression element forms a type of spring element. This compression element, or spring element, has resilient properties, resulting in a resilient compression potential for the temperature control element over the length of the unit due to the resilient compression of the compression element, or spring element. The spring element exerts a force over the length of the unit on the two temperature control plates and/or against an external force exerted on the temperature control element. The spring force exerted on the plates by the spring element preferably increases as the compression of the temperature control element increases, preferably in a linear manner, progressively or degressively. The compression element is ideally resiliently compressible. Conceivably, the temperature control element can return to the uncompressed state, or at an least less compressed state, from the compressed state, due to the resilient properties of the compression element. This is relevant when the batteries shrink, to maintain a predefined tension within a stack of batteries. Ideally, the compression element is not made of foam, or does not contain any foam.

The aforementioned spring element can be a corrugated piece of sheet metal. The troughs and peaks alternate, such that the peaks bear on a first temperature control plate and the troughs bear on second temperature control plate. This corrugated sheet metal is preferably a single piece, or it can be composed of numerous pieces. This results in a spring element that can be produced inexpensively. Ideally, the peaks, and/or troughs formed in the corrugated sheet metal are parallel to one another. The troughs and peaks can transition directly into one another.

The corrugated sheet metal could also have a flat base, in which the peaks are formed by parallel profile elements thereon, raised above a first side of the base, and/or the troughs are formed by second parallel profile elements on the base, which are raised above the other side of the base. These first and/or second profile elements preferably have a rectangular cross section. This results in another effective spring element.

The compression element is preferably entirely within a space formed between the two temperature control plates, which can also contain at least one fluid, preferably a gas or mixture of gasses, specifically air. In another variation, a fluid can flow through this space.

In the first version, the space can be sealed off, such that none of the fluid, preferably a gas or mixture of gasses, ideally air, can escape into the exterior, and no other fluid can enter the space. In this version, it may be advantageous to make the compression element from plastic, resulting in an effective thermal barrier that can be produced inexpensively.

In the second version, there can be holes on opposite sides of the temperature control element through which coolant can enter and exit the space, thus flowing over the compression element therein for purposes of heat exchange. In this case, the space forms a kind of additional channel, also referred to below as a compression chamber. This results in a temperature control element with a comparatively large cross section through which coolant can flow, such that the temperature of the batteries can be more effectively controlled. When the temperature control element is compressed, the channels in the two temperature control plates ensure a (constant) minimum cross section through which the coolant can flow (thus providing a minimum temperature control), because their cross sections remain substantially the same when the temperature control element is compressed. In this case, it may be advantageous to make the compression element out of metal, because this results in a more effective heat transfer.

In particular, the two temperature control plates can have flat outer surfaces where they bear on batteries, which are perpendicular to the axis passing through the row, with back surfaces on the other sides of the plates. The plates also have connecting tabs on opposite edges that extend beyond the backs thereof, with which the plates are connected to one another. These tabs can be glued, brazed or welded, in particular laser welded, to one another. The backs and tabs contain the space. The compression element bears linearly on the backs of the two temperature control plates. As a result, at least two batteries can be placed on the two outer surfaces of the temperature control element. The compression element is placed in the space formed between the two plates. The tabs can be somewhat flexible, such that they do not prevent compression of the compression element between the plates.

The temperature control plates can be made of aluminum in a continuous casting process. This results in an inexpensive production process, such that they can easily be made of different sizes. The temperature control plates can also be identical.

The second object of the invention is achieved by a temperature control system containing numerous temperature control elements described above, which are incorporated in a coolant circuit. These temperature control elements are preferably connected in parallel or in a series, such that the coolant can flow through them in parallel, or sequentially. This results in an advantageous temperature control system with numerous temperature control elements.

The third object of the invention is achieved by a battery system for an electric or hybrid vehicle that contains numerous batteries in a stack, with numerous temperature control elements described above, or a temperature control system described above. The batteries are spaced apart within the stack, with the temperature control elements placed between them, such that each battery is adjacent to at least one of the temperature control elements. This results in an advantageous battery system for a vehicle, in which the temperature of the batteries can basically be controlled independently of any swelling of the batteries within the stack.

Other important features and advantages of the invention can be derived from the dependent Numbered Paragraphs, drawings, and descriptions of the drawings.

It is understood that the features specified above and described below can be used not only in the given combinations, but also in other combinations or in and of themselves, without abandoning the scope of protection for the present invention. Components of a higher-order unit, e.g. an element, device, or assembly, specified above or below, which are indicated separately, can form separate components of this unit, or be integral parts thereof, even if otherwise indicated in the drawings.

Preferred exemplary embodiments of the invention are shown in the drawings and shall be explained in greater detail below, in which the same reference symbols are used for the same, similar, or functionally identical components.

Therein, schematically,

FIG. 1 shows a perspective view of a first embodiment of the temperature control element obtained with the invention,

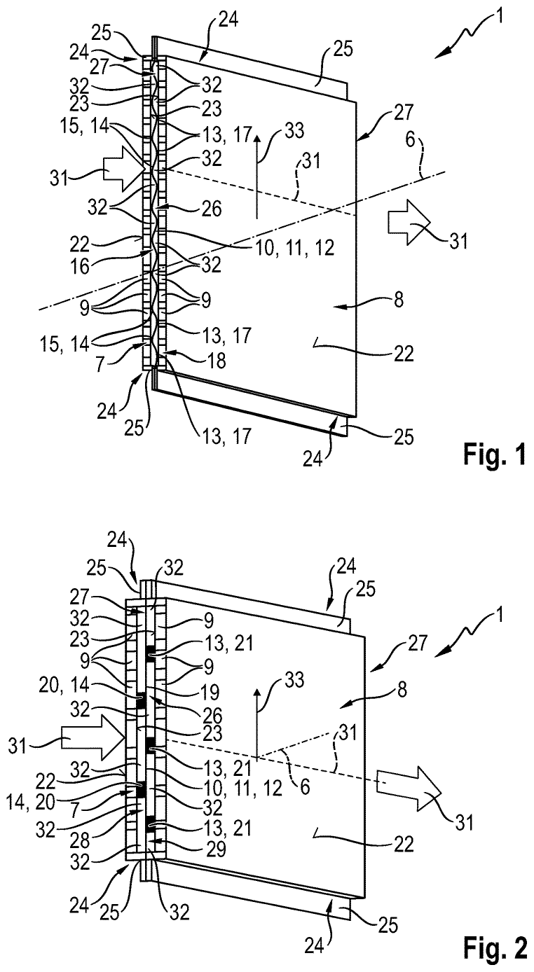

FIG. 2 shows a perspective view of a second embodiment of the temperature control element obtained with the invention,

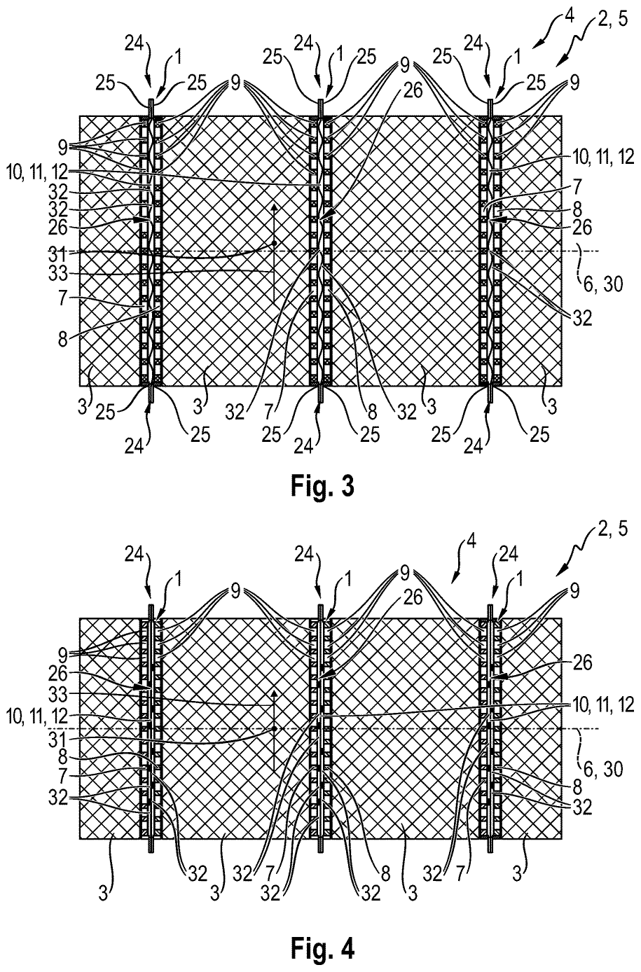

FIG. 3 shows a sectional view of a highly simplified battery system for a vehicle that contains numerous temperature control elements in accordance with the first embodiment, and

FIG. 4 shows a sectional view of another highly simplified battery system for a vehicle that contains numerous temperature control elements in accordance with the second embodiment.

FIG. 1 shows a perspective view of a first embodiment of the temperature control element 1 obtained with the invention for batteries 3 in a stack 4 within a battery system 5.

The temperature control element 1 contains two parallel, flat, single-piece and identical temperature control plates 7, 8, made of aluminum in a continuous casting process, each of which contains numerous parallel channels 9. A coolant can flow through channels 9, which have a rectangular cross section here, to control the temperature of these batteries 3. A flow path for the coolant is indicated by a broken line in the channels 9 in the temperature control plates 7, 8, which defines a longitudinal axis 31.

FIG. 1 also shows that the temperature control plates 7, 8 each have a flat outer surface 22 for accommodating the batteries 3 (i.e. on which the batteries lie), as well as a back surface 23 on the other side. The temperature control plates 7, 8 also have connecting tabs 25 on opposite edges 24 along the lateral axis 33, which is orthogonal to the longitudinal axis 31, which extend beyond the backs 33 of the temperature control plates 7, 8. These tabs 25 have an L-shaped cross section, and/or can be integral parts of the plates 7, 8, or can be glued or welded thereto, in particular with a laser beam welding process.

The temperature control plates 7, 8 can be connected to one another by only these tabs 25, such that their backs 23 are on opposite sides along the axis 6 passing through the row of plates, which is orthogonal to both the longitudinal axis 31 and the lateral axis 33. These tabs 25 can be glued or welded together, in particular in a laser beam welding process.

FIG. 1 also shows that the two backs 23 of the temperature control plates 7, 8 and the tabs 25 thereon encompass a space 26 between them. A compression element 10 is placed therein that bears linearly directly on the two backs 23 of the plates 7, 8. The compression element 10 can be compressed along the axis 6 passing through the row of plates, and divides the space 26 into numerous compression chambers 32, which can be filled with a gas or mixture of gasses, specifically air, or through which a fluid can flow along the longitudinal axis 31 for additional temperature control of the batteries 3. This allows the temperature control element 1 to be compressed along the axis 6 passing through the row of plates, resulting in a certain amount of flexibility in the proposed temperature control element 1 along this axis 6.

This means that swelling of the batteries 3 along this axis 6 caused by the charging state or aging can be compensated for. Moreover, the mechanical rigidity of the compression element 10 is lower than that of the two temperature control plates 7, 8. Consequently, only the compression element 10 is compressed along this axis 6, leaving the channels 9 in the plates 7, 8 substantially intact. Consequently, the flow of coolant through the channels 9 in the plates 7, 8 remains substantially constant, such that the temperature of the batteries 3 is constantly controlled when in use.

The compression element 10 in FIG. 1 forms a resilient spring element 11. This is a corrugated piece of sheet metal 12 with troughs 13 and peaks 14, which alternate over the longitudinal axis 31, extending along the lateral axis 33. Furthermore, the peaks 14 bear linearly on the back 23 of a first temperature control plate 7 at first contact surfaces, and the troughs 13 bear linearly on the back 23 of a second temperature control plate 8 at second contact surfaces. The peaks 14 are formed by parallel bulges 15 rising from a first side 16 of the sheet metal 12. The troughs 13 are formed by parallel counter-bulges 17 in the sheet metal 12, rising from a second side 18 of the sheet metal 12. The main direction of extension of these bulges 15 and/or counter-bulges 17 is transverse to the axis 6 passing through the row of plates. The first contact surfaces can be linear. The second contact surfaces can also be linear.

FIG. 1 also shows that the space 26, or the compression chamber 32, has holes 27 at opposite sides of the temperature control element 1 through which coolant can enter and exit the space 26, or compression chambers 32. Consequently, coolant can flow over the compression element 10 in the space 26, to effectively remove exhaust heat from the batteries 3. In another embodiment, not shown here, the space 26, or the holes 27, can be sealed, such that the coolant does not flow through the space 26.

FIG. 2 shows a perspective view of a second embodiment of the temperature control element 1 obtained with the invention. This embodiment differs from that in FIG. 1 in that the spring element 11 is a corrugated sheet metal 12 with troughs 13 and peaks 14 formed by a flat base 19 and first and second profile elements 20 and 21. The first profile elements 20 are parallel to one another and on a first side 28 of the base 19. These first profile elements 20 rise above the first side 28 of the base 19, thus forming the peaks 14. The second profile elements 21 are also parallel to one another and on the other side 29 of the base 19. These second profile elements 21 rise above the second side 29 of the base 19, thus forming the troughs 13.

FIG. 3 shows a sectional view of a highly simplified battery system 5 for a vehicle, not shown. It contains numerous batteries 3, spaced apart along a stacking axis 30. The batteries 3 form a stack 4. The battery system 5 also contains a temperature control system 2 for the batteries 3, which contains numerous temperature control elements 1, which are of the first embodiment shown in FIG. 1. The temperature control elements 1 are between adjacent batteries 3 along the axis 6 parallel to the stacking axis 30, and the batteries bear on the outer surfaces 22 of adjacent temperature control elements 1, thus enabling heat exchange between the temperature control elements 1 and the batteries 3. This results in an advantageous battery system 5, in which temperature control of the batteries 3 is basically independent of any expansion of the batteries 3 along the stacking axis 30.

FIG. 4 shows another battery system 5 for a vehicle, not shown, which contains the second embodiment of the temperature control elements 1 shown in FIG. 2, instead of those shown in FIG. 1.

The specification can be readily understood with reference to the following Numbered Paragraphs:

Numbered Paragraph 1. A temperature control element (1) for batteries (3) in a stack (4) forming a battery system (5) for an electric or hybrid vehicle,
which has two temperature control plates (7, 8) along an axis (6) passing through a row of plates, each of which has at least one channel (9) through which a coolant can flow for controlling the temperature of the batteries (3), on each of which one of the batteries (3) can be placed,
which has at least one compression element (10) between the temperature control plates (7, 8) that can be compressed along the axis (6) passing through the row of plates, and bears on the two temperature control plates (7, 8) to form compression chambers (32),
wherein the compression element (10) is made of a material that functions as a thermal conductor, preferably a metal,
wherein the compression chambers (32) are filled with a gas or mixture of gasses, in particular air, or through which a fluid can flow for additional temperature control of the batteries (3).

Numbered Paragraph 2. The temperature control element (1) according to Numbered Paragraph 1, characterized in that the mechanical rigidity of the compression element (10) along the axis (6) passing though the plates is lower than the mechanical rigidity of the two temperature control plates (7, 8) along this axis (6).

Numbered Paragraph 3. The temperature control element (1) according to Numbered Paragraph 1 or 2, characterized in that the compression element (10) can be resiliently compressed along the axis (6) passing through the plates.

Numbered Paragraph 4. The temperature control element (1) according to any of the preceding Numbered Paragraphs, characterized in that the compression element (10) forms a spring element (11).

Numbered Paragraph 5. The temperature control element (1) according to Numbered Paragraph 4, characterized in that the spring element (11) is a corrugated piece of sheet metal (12) with troughs (13) and peaks (14), wherein the troughs (13) and peaks (14) preferably alternate and the peaks (14) bear on a first temperature control plate (7) and the troughs (13) bear on a second temperature control plate (8).

Numbered Paragraph 6. The temperature control element (1) according to Numbered Paragraph 5, characterized in that
the peaks (14) are formed by parallel bulges (15) rising from a first side (16) of the sheet metal (12), and
the troughs (13) are formed by parallel counter-bulges (17) rising from a second side (18) of the sheet metal (12), opposite the first side (16).

Numbered Paragraph 7. The temperature control element (1) according to Numbered Paragraph 5, characterized in that
the corrugated sheet metal (12) has a flat base (19),
the peaks (14) are formed by parallel first profile elements (20) on the base (19), rising from a first side (28) of the base (19), and
the troughs (13) are formed by parallel second profile elements (21) on the base (19), rising from a second side (29) of the base (19), opposite the first side (28).

Numbered Paragraph 8. The temperature control element (1) according to any of the preceding Numbered Paragraphs, characterized in that the compression element (10) is preferably entirely within a space (28) formed between the two temperature control plates (7, 8) along the axis (6) passing through the plates, in which, in addition to the compression element (10), at least one fluid, preferably a gas or mixture of gasses, in particular air, is contained, or through which a fluid can flow.

Numbered Paragraph 9. The temperature control element (1) according to Numbered Paragraph 8, characterized in that
a coolant can flow through the space (26), or the space is sealed off, and/or
holes (27) on opposite sides of the temperature control element (1) allow coolant to enter and exit the space (26), such that coolant can flow over the compression element (10) in the space (26) for purposes of heat exchange.

Numbered Paragraph 10. The temperature control element (1) according to Numbered Paragraph 8, characterized in that the space (26) is sealed off at its edges.

Numbered Paragraph 11. The temperature control element (1) according to any of the Numbered Paragraphs 8 to 10, characterized in that
the two temperature control plates (7, 8) each have a flat outer surface (22) for accommodating a battery (3), and a back surface (23) on the other side,
the two temperature control plates (7, 8) are placed along the axis (6) passing through the plates, with their backs (23) facing one another at a right angle to this axis (6),
the temperature control plates (7, 8) each have connecting tabs (25) on opposite edges (24), extending beyond their backs (23),
the plates (7, 8) are connected to one another by these tabs (25),
the backs (23) and tabs (25) encompass the space (26),
the compression element (10) bears linearly on the backs (23) of the temperature control plates (7, 8).

Numbered Paragraph 12. The temperature control element (1) according to any of the preceding Numbered Paragraphs, characterized in that the two temperature control plates (7, 8) are preferably monolithic aluminum profile elements produced in a continuous casting process.

Numbered Paragraph 13. A temperature control system (2) that contains numerous temperature control elements (1) according to any of the preceding Numbered Paragraphs 1 to 12, each of which is incorporated in a coolant circuit in the temperature control system (2), wherein the temperature control elements (1) are preferably connected in parallel or in a series, such that coolant can flow through them in parallel or sequentially.

Numbered Paragraph 14. A battery system (5) for an electric or hybrid vehicle, containing numerous batteries (3) in a stack (4) with numerous temperature control elements (1), each of which is formed in accordance with any of the preceding Numbered Paragraphs 1 to 12, or containing a temperature control system (2) according to Numbered Paragraph 13, wherein the batteries (3) are spaced apart along a stacking axis (30), wherein the temperature control elements (1) are placed between adjacent batteries (3), and the batteries (3) each bear on at least one of the temperature control elements (1).

### LIST OF REFERENCE SYMBOLS

1 temperature control element
2 temperature control system
3 batteries
4 stack of batteries
battery system
6 axis passing through the row of plates
7 first temperature control plate
8 second temperature control plate
9 channel
10 compression element
11 spring element
12 corrugated sheet metal
13 troughs
14 peaks
15 bulges
16 first side
17 counter-bulges
18 second side
19 base
20 first profile elements
21 second profile elements
22 outer surface
23 back surface
24 edges
25 connecting tabs
26 space
27 holes
28 first side of the base
29 second side of the base
30 stacking axis
31 longitudinal axis
32 compression chambers
33 lateral axis

1-14. (canceled)

15. A temperature control element for batteries in a stack forming a battery system for an electric or hybrid vehicle, comprising:
two temperature control plates disposed in a row, with an axis passing through the row of plates, each temperature control plate has at least one channel through which a coolant can flow for controlling the temperature of the batteries, on each of which is configured to have one of the batteries placed thereon,
further comprising at least one compression element between the temperature control plates, the at least one compression element is configured to be compressed along the axis passing through the row of plates, the at least one compression element bears on the two temperature control plates to define compression chambers,
wherein the at least one compression element is made of a material that functions as a thermal conductor,
wherein the compression chambers are filled with a gas or mixture of gasses, in particular air, or through which a fluid can flow for additional temperature control of the batteries.

16. The temperature control element according to claim 15, wherein a mechanical rigidity of the at least one compression element along the axis passing though the plates is lower than a mechanical rigidity of the two temperature control plates along the axis.

17. The temperature control element according to claim 15, wherein the at least one compression element is configured to be resiliently compressed along the axis passing through the plates.

18. The temperature control element according to claim 15, wherein the at least one compression element is a spring element.

19. The temperature control element according to claim 18, wherein the spring element is a piece of sheet metal that is with a plurality of troughs and a plurality of peaks, wherein the troughs and peaks alternate and the peaks bear on a first temperature control plate of the two temperature control plates and the troughs bear on a second temperature control plate of the two temperature control plates.

20. The temperature control element according to claim 19, wherein
the plurality of peaks are defined by parallel bulges rising from a first side of the sheet metal, and
the plurality of troughs are defined by parallel counter-bulges rising from a second side of the sheet metal, opposite the first side.

21. The temperature control element according to claim 19, wherein
the piece of sheet metal has a flat base,
the plurality of peaks are formed by parallel first profile elements on the base, rising from a first side of the base, and
the plurality of troughs are formed by parallel second profile elements on the base, rising from a second side of the base, opposite the first side.

22. The temperature control element according to claim 15, wherein the at least one compression element is entirely within a space formed between the two temperature control plates along the axis passing through the two plates, in which, in addition to the at least one compression element, at least one fluid and/or a gas or mixture of gasses including air, is contained, or through which is configured for a fluid to flow therethrough.

23. The temperature control element according to claim 22, wherein the space is configured for a coolant to flow therethrough, or the space is sealed off, and/or holes are provided on opposite sides of the temperature control element and are configured for coolant to enter and exit the space, such that coolant flows over the compression element in the space for purposes of heat exchange.

24. The temperature control element according to claim 22, wherein the space is sealed off at its edges.

25. The temperature control element according to any of the claim 22, wherein
the two temperature control plates each have a flat outer surface that are configured for accommodating a battery, and a back surface on an other side thereof,
the two temperature control plates are disposed along the axis passing through the two temperature control plates, with backs of the two temperature control plates facing one another at a right angle to this axis,
the two temperature control plates each have connecting tabs on opposite edges, extending beyond their backs,
the two temperature control plates are connected to one another by these tabs,
the backs and tabs encompass the space,
the at least one compression element bears linearly on the backs of the two temperature control plates.

26. The temperature control element according to claim 15, wherein the two temperature control plates are monolithic aluminum profile elements produced in a continuous casting process.

27. A temperature control system comprising a plurality of temperature control elements according to claim 15, each of which is incorporated in a coolant circuit in the temperature control system, wherein the temperature control elements are connected in parallel or in a series, such that coolant can flow through them in parallel or sequentially, respectively.

28. A battery system for an electric or hybrid vehicle, comprising a plurality of batteries in a stack with a plurality of temperature control elements, each of the plurality of temperature control elements is formed according to claim 15, wherein the batteries are spaced apart along a stacking axis, wherein the temperature control elements are placed between adjacent batteries, and the batteries each bear on at least one of the temperature control elements.

29. The battery system of claim 28, wherein each temperature control element is incorporated in a coolant circuit in the temperature control system, wherein the temperature control elements are connected in parallel or in a series, such that coolant can flow through them in parallel or sequentially, respectively.
